(19) United States
(12) Patent Application Publication
(10) Pub. No.: US 2010/0209869 A1
(43) Pub. Date: Aug. 19, 2010

(54) Bone Substitute Packing Funnel Used In Socket Lift

(76) Inventor: Hideaki Ueda, Kitakyushu-city (JP)

Correspondence Address: TOWNSEND & BANTA;c/o PORTFOLIO IP, PO BOX 52050, MINNEAPOLIS, MN, 55402, US

(21) Appl. No.: 12/630,968

(22) Filed: Dec. 4, 2009

(30) Foreign Application Priority Data
Feb. 19, 2009 (JP) 2009-036429

(51) Int. Cl. A61C 8/00

(52) U.S. Cl. 433/89

(57) ABSTRACT

A bone substitute packing funnel includes a large diameter opening portion having a plane surface area which allows insertion of a spoon on which a bone substitute is placed, a connecting portion connecting a small diameter opening portion and the large diameter opening portion continuously and being formed in such a manner that an inner wall surface is inclined with respect to a line connecting a center portion of the small diameter opening portion and a center portion of the large diameter opening portion, and the small diameter opening portion to be inserted into a hole formed on maxilla of a patient from the side where a dental-implant is to be embedded, the small diameter opening portion introducing the bone substitute being moved from the large diameter opening portion and the connecting portion into the hole, when being inserted into the hole.

The present application claims priority under 35 U.S.C. 119 and 37 C.F.R. 1.55 of prior Japanese Patent Application No. 036429/2009, filed Feb. 19, 2009, the contents of which are incorporated herein by reference.

### BACKGROUND OF THE INVENTION

1. Technical Field

The present invention relates to an instrument used in Socket Lift (a technique included in Sinus Lift) for lifting maxillary sinus floor performed in the run-up to a process of embedding a dental-implant in the field of dentistry.

2. Description of the Related Art

In the related art, Sinus Lift is performed in the run-up to a process of embedding a dental-implant in the field of dentistry. The Sinus Lift is performed for increasing a bone mass on a maxillary sinus floor of a patient which enables a dental-implant to be embedded therein when a patient does not have enough bone mass required for embedding the dental-implant because the level of the maxillary sinus floor of the patient is too low.

Known as one of techniques in the Sinus Lift is Socket Lift which is a technique to lift the maxillary sinus floor and proliferate bone by forming a hole on ridge (residual ridge) of the maxilla of the patient with a drill or the like from the side (or in a place) where the dental-implant is to be embedded, and moving a bone substitute in this hole onto the maxillary sinus floor by transferring the bone substitute into this hole and pushing out the same toward the maxillary sinus.

In the Socket Lift as described above, in order to put the bone substitute into the hole, a method of sprinkling the bone substitute placed on a spoon directly into the hole, or a method of inserting a distal end of a syringe (injection syringe) containing the bone substitute stored therein into the hole and filling the bone substitute from a discharge port at the distal end into the hole is employed in the related art.

JP-A-2006-61377 is an example of related art.

However, the method of sprinkling the bone substitute placed on the spoon directly into the hole has a problem such that considerable amount of the bone substitute placed on the spoon flies in all directions therearound instead of entering the hole, a large amount of the precious bone substitute is wasted (collecting the bone substitute flown around the hole with a rod-shaped filling tool and putting the same into the hole is not desirable because it is highly likely that foreign substance such as blood is attached to the flown-around bone substitute and hence there is a risk of induction of infection by the foreign substance such as the blood for the patient). Also, the method of inserting the distal end of the syringe (injection syringe) containing the bone substitute stored therein into the hole and filling the bone substitute from the discharge port at the distal end into the hole has a problem such that the interior of the distal end portion is clogged and hence smooth discharge and filling of the bone substitute cannot be achieved due to such reasons that the bone substitute is hardened in the interior of the syringe and the like.

### SUMMARY OF THE INVENTION

In view of such problems in the related art, it is an object of the present invention to provide a bone substitute packing funnel used in Socket Lift which enables a bone substitute placed on a spoon to be packed into a hole efficiently without sprinkling the same around the hole and, consequently, enables the Socket Lift to be performed smoothly in a short time.

In order to solve the problems in the related art as described above, a bone substitute packing funnel used in Socket Lift according to the invention is a bone substitute packing funnel used in Socket Lift for increasing a bone mass of maxilla of a patient to an amount which enables embedding of a dental-implant in the maxilla by proliferating the bone of the maxilla on maxillary sinus floor of the patient by forming a hole on the maxilla of the patient from the side (or in a place) where the dental-implant is to be embedded and placing a (powdered) bone substitute onto the maxillary sinus floor of the maxilla via the hole, when the bone mass of the maxilla of the patient is insufficient for embedding the dental-implant because the level of maxillary sinus floor is too low, including:

a large diameter opening portion having a plan surface area (a surface area in the plan view) for allowing insertion of a spoon on which the bone substitute is placed and being configured to receive the bone substitute placed on the spoon from the spoon in a mouth cavity of the patient;

a small diameter opening portion formed into a cylindrical shape having an outer diameter not exceeding 6 mm, an inner diameter not smaller than 2 mm, and a length in the longitudinal direction from 2 to 10 mm, and being configured to be inserted into the hole formed on the maxilla of the patient from the side (or in the place) where the dental-implant is to be embedded, the small diameter opening portion allowing the bone substitute being transferred from the large diameter opening portion to be transferred into the hole through the small diameter opening portion, allowing a substantially rod-shaped filling tool to be introduced into the hole through the small diameter opening portion, and allowing the bone substitute in the hole to move onto the maxillary sinus floor by the filling tool passed through the small diameter opening portion pushing out the bone substitute toward the maxillary sinus floor, when the small diameter opening portion is inserted into the hole in the mouth cavity of the patient; and

a connecting portion configured to connect the small diameter opening portion and the large diameter opening portion continuously and having an inner wall surface formed so as to incline with respect to a line connecting a center portion of the small diameter opening portion and a center portion of the large diameter opening portion, the connecting portion being configured to transfer the bone substitute received from the spoon into the large diameter opening portion of the funnel from the large diameter opening portion toward the small diameter opening portion smoothly in the mouth cavity of the patient.

Preferably, the large diameter opening portion of the bone substitute packing funnel in the invention has a projection having a curved surface to which a substantially entire portion of a depressed surface of the spoon on which the bone substitute is placed can abut.

Preferably, the large diameter opening portion has a depression having a curved surface to which an outer peripheral surface of a distal end portion of the filling tool can abut.

Preferably, the large diameter opening portion or the connecting portion has a substantially rod-shaped handle that a user uses for supporting the funnel when inserting the small diameter opening portion of the funnel into the hole or for supporting the funnel when the small diameter opening portion of the funnel is inserted into the hole, and that is extending from the large diameter opening portion or the connecting portion.

Preferably, at least one of the large diameter opening portion, the connecting portion, and the handle has an attachment portion for attaching a string or a cord for preventing erroneous swallowing of the funnel.

According to the embodiments of the invention, in the Socket Lift performed for increasing the bone mass of the maxilla on maxillary sinus floor when the bone mass of the maxilla of the patient is insufficient for embedding the dental-implant therein because the level of the maxillary sinus floor of the patient is too low, a hole is formed on the maxilla from the side (or in the place) where the dental-implant is to be embedded and the small diameter opening portion of the funnel on the lower end side thereof is inserted to the hole from an opening of the hole.

Then, the (powdered) bone substitute is placed on the spoon. Then, the bone substitute placed on the spoon is transferred from the spoon into the large diameter opening portion. The bone substitute transferred into the large diameter opening portion is moved downward smoothly on the inclined inner wall surface of the connecting portion and is transferred into the small diameter opening portion by its own weight. Then, the rod-shaped distal end portion of the filling tool is inserted into the (cylindrical) small diameter opening portion and the hole via the large diameter opening portion. Then, the bone substitute transferred from the small diameter opening portion into the hole is pushed toward the maxillary sinus by the rod-shaped distal end portion of the filling tool so as to move the same onto the maxillary sinus floor (to move the same between a bone surface of the maxillary sinus floor and a mucous membrane on the bone surface of the maxillary sinus floor), so that bone is proliferated on the maxillary sinus floor.

At this time, since the small diameter opening portion is formed to have the outer diameter not exceeding 6 mm, it can be inserted smoothly into the hole formed on the maxilla from the side (or in the place) where the dental-implant is to be embedded, because the outer diameter of the dental-implant is 6 mm at the maximum as the matter stands, and hence the diameter of the hole is always formed so as not to exceed 6 mm. Also, since the small diameter opening portion is formed to have the inner diameter of 2 mm or larger, the bone substitute transferred from the large diameter opening portion and the connecting portion is introduced and moved smoothly (without being clogged in the midpoint) into the hole, because the bone substitute can be moved smoothly through a cylinder having an inner diameter of 2 mm or larger without being clogged.

At this time, since the large diameter opening portion has a size which allows insertion of the distal end portion of the spoon with the bone substitute (a plan size for allowing the insertion of the depressed surface of the spoon), the substantially entire part of the bone substitute placed on the spoon can be transferred into the large diameter opening portion easily (without causing the same to fly in all directions around the hole).

Also, since the connecting portion is formed in such a manner that the inner wall surface is inclined with respect to the line connecting the center portion of the small diameter opening portion and the center portion of the large diameter opening portion, the bone substitute moved into the large diameter opening portion is moved downward on the inclined surface of the connecting portion easily and smoothly by its own weight and is transferred to the small diameter opening portion.

According to the invention, since the projection having the curved surface to which the substantially entire portion of the depressed surface of the spoon can abut is formed on the large diameter opening portion, the bone substitute adhered to (remaining on) the depressed surface of the spoon all can be transferred to the large diameter opening portion by the user by rubbing the depressed surface of the spoon against the curved surface of the projection (moving in a state of being abutted) after having ended the operation to move the bone substitute from the spoon to the large diameter opening portion. Accordingly, a problem of waste such that the precious bone substitute which currently costs twenty to several tens of thousands yens per one gram is thrown away in a state of being adhered to (remaining on) the depressed surface of the spoon is avoided.

Also, according to the invention, since the depression having the curved surface to which the outer peripheral surface of the rod-shaped distal end portion of the filling tool can abut is formed on the large diameter opening portion, the bone substitute adhered to (remaining on) the outer peripheral surface of the filling tool all can be transferred to the large diameter opening portion by the user by rubbing the outer peripheral surface of the filling tool against the curved surface of the depression (moving in the state of being abutted) after having ended the operation to press the bone substitute in the hole toward the maxillary sinus floor using the filling tool and moving the bone substitute onto the maxillary sinus floor. Accordingly, the problem of waste such that the precious bone substitute which currently costs twenty to several tens of thousands yens per one gram is thrown away in the state of being adhered to (remaining on) the outer peripheral surface of the filling tool is avoided.

According to the invention, since there is provided the handle extending from the large diameter opening portion or the connecting portion of the bone substitute packing funnel, which is the substantially rod-shaped handle used by the user for supporting the funnel when inserting the small diameter opening portion of the funnel into the hole, or for supporting the funnel in the state in which the small diameter opening portion is inserted into the hole, the operation of the spoon or the filling tool in one hand while holding the funnel with the other hand is enabled in the Socket Lift, and hence the Socket Lift can be performed stably and smoothly.

According to the invention, since at least one of the large diameter opening portion, the connecting portion, and the handle has the attachment portion for attaching one of ends of the string or the cord, occurrence of the erroneous swallowing of the funnel during the operation of the Socket Lift is effectively prevented. The other end (free end) of the string or the cord is preferably attached to a finger of an operator or other portions.

### BRIEF DESCRIPTION OF THE DRAWINGS

FIG. 1 is a perspective view of a bone substitute packing funnel according to a first embodiment of the invention;

FIG. 2(a) is a plan view of the bone substitute packing funnel according to the first embodiment;

FIG. 2(b) is a front view of the same;

FIG. 2(c) is a bottom view of the same;

FIG. 2(d) is a right side view of the same;

FIG. 2(e) is a left side view of the same;

FIG. 3 is a perspective view showing the bone substitute packing funnel according to the first embodiment;

FIG. 4 is a perspective view showing the bone substitute packing funnel according to the first embodiment;

FIG. 5 is a perspective view showing the bone substitute packing funnel according to the first embodiment;

FIG. 6 is a perspective view showing the bone substitute packing funnel according to the first embodiment;

FIG. 7 is a perspective view showing a double-head instrument having a spoon at one end thereof and a rod-shaped filling tool at the other end thereof and being used in Socket Lift performed by using the funnel according to the first embodiment;

FIG. 8 is a perspective view showing the spoon at one end of the double-head instrument shown in FIG. 7 in an enlarged scale.

FIG. 9 is an explanatory drawing showing a configuration and an operation of a projection at a large diameter opening portion according to the first embodiment; and

FIG. 10 is an explanatory drawing showing a configuration and an operation of a depression at the large diameter opening portion according to the first embodiment.

### DESCRIPTION OF THE PREFERRED EMBODIMENTS

A best mode for carrying out the invention is a mode as described in a first embodiment described below.

### First Embodiment

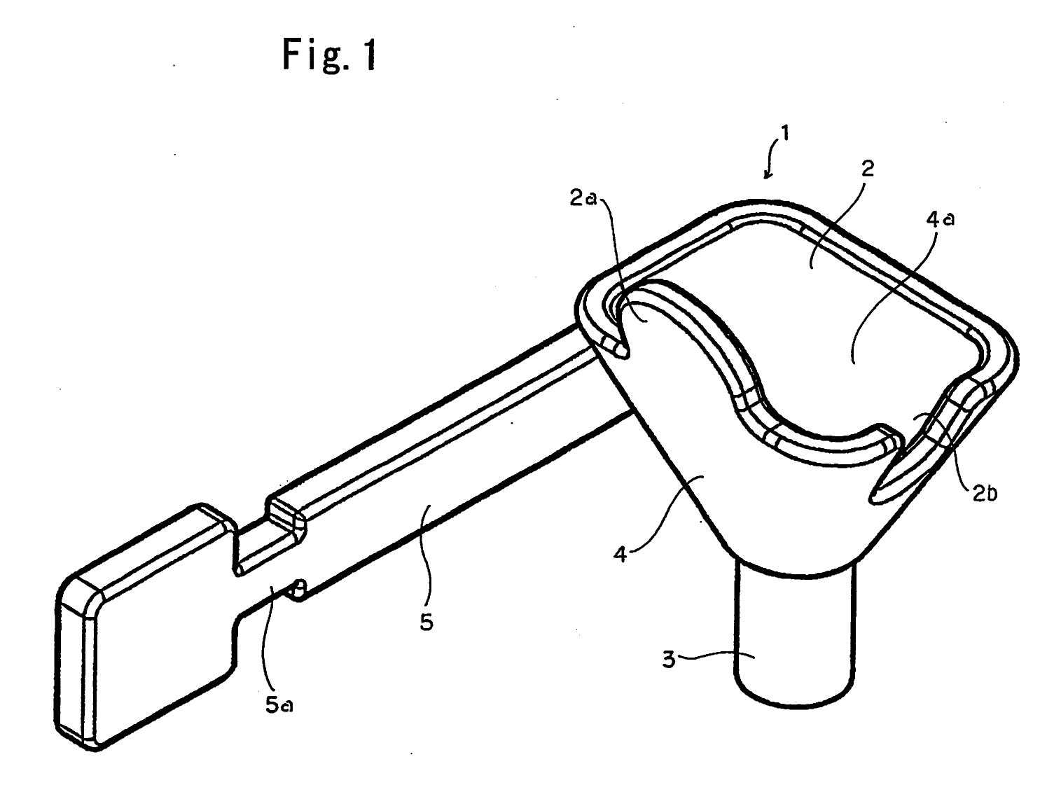

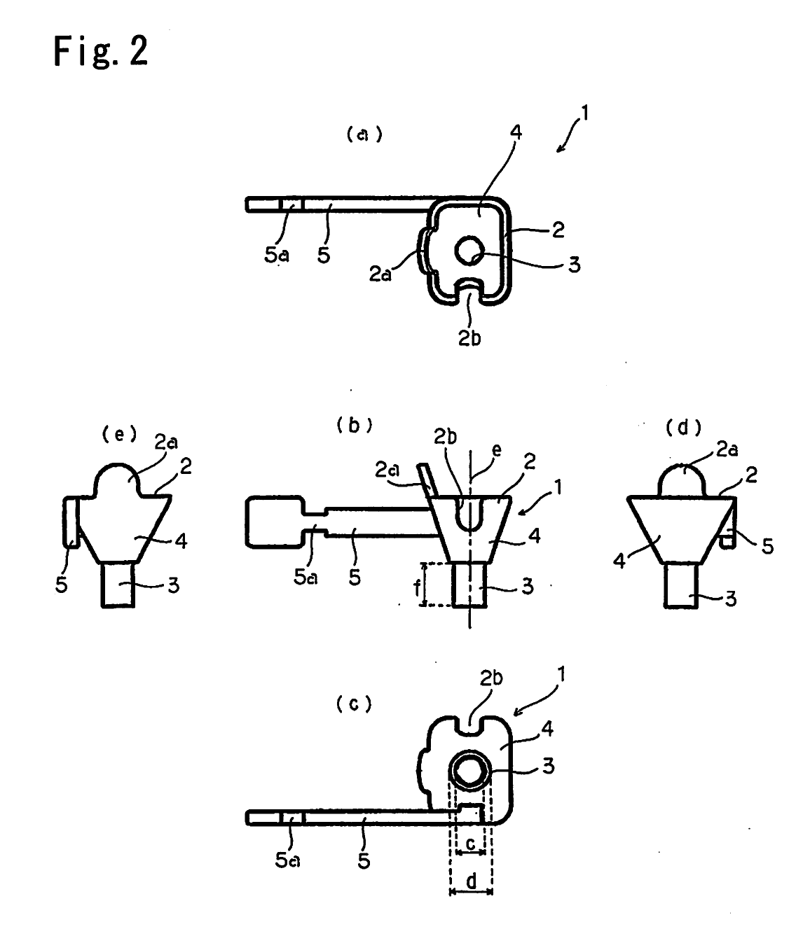

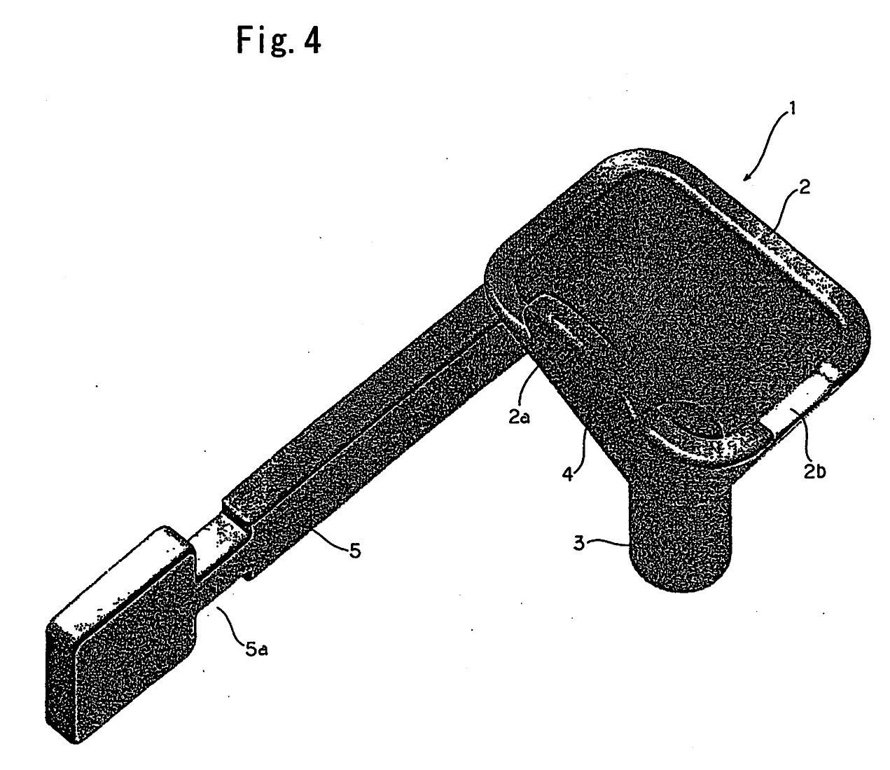

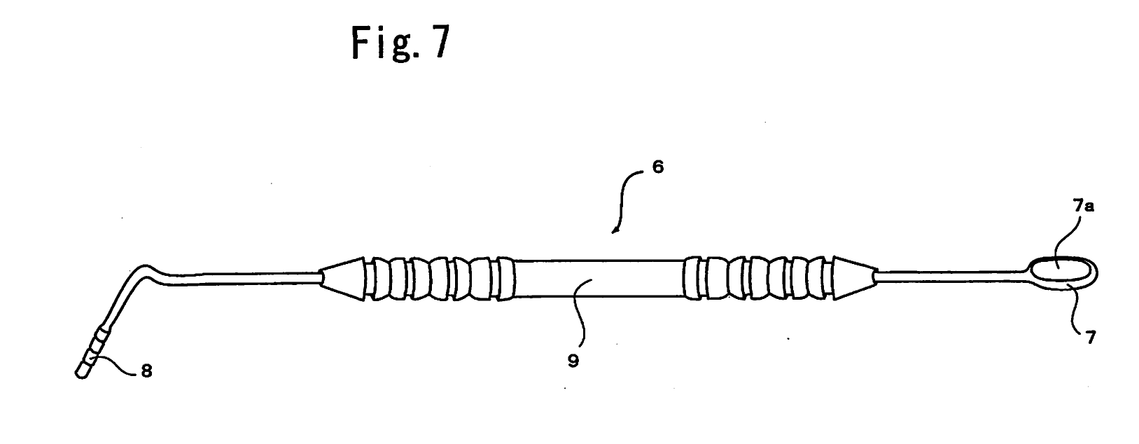

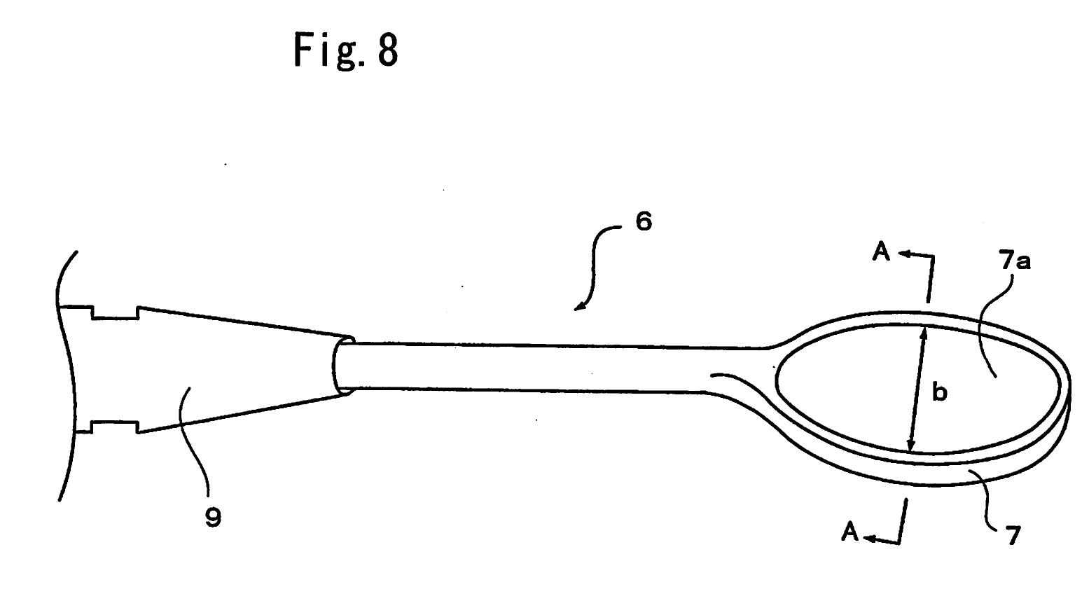

FIG. 1 and FIGS. 3 to 6 are drawings showing the first embodiment of the invention, and a perspective view illustrating a bone substitute packing funnel formed integrally of, for example, a stainless steel material. FIGS. 2(a) to 2(e) are a plan view, a front view, a bottom view, a right side view, and a left side view of the first embodiment; FIG. 7 is a perspective view of a double-head instrument having a spoon at one end thereof and a filling tool at the other end thereof and being used in Socket Lift performed by applying the first embodiment; and FIG. 8 is a perspective view of the spoon in FIG. 7 in an enlarged scale.

In FIG. 1 and FIGS. 3 to 6, reference numeral 1 designates a funnel according to the first embodiment, reference numeral designates a large diameter opening portion of a substantially rectangular shape in plan view, which constitutes an upper portion of the funnel 1 in the drawing, reference numeral 3 designates a small diameter opening portion of a substantially cylindrical shape, which constitutes a lower portion of the funnel 1 in the drawing, reference numeral 4 designates a connecting portion for connecting the large diameter opening portion 2 and the small diameter opening portion 3, and reference numeral 5 designates a rod-shaped handle provided so as to project from part of the connecting portion 4.

In FIGS. 7 and 8, reference numeral 6 designates a double-head instrument formed of, for example, stainless steel, reference numeral 7 designates a spoon for moving bone substitute formed at one end of the double-head instrument 6, reference numeral 8 designates a rod-shaped filling tool for packing the bone substitute formed at the other end of the double-head instrument 6, and reference numeral 9 designates a joint portion which joins the spoon 7 and the filling tool 8. A cover formed, for example, of plastic is provided on the outer surface of the joint portion 9.

The angle and size of the spoon 7 and a plan surface area (a surface area in the plan view) and shape of the large diameter opening portion 2 of the funnel 1 are determined so as to match with respect to each other, so that the substantially entire part of the spoon 7 can be inserted easily within the large diameter opening portion 2 of the funnel 1. Lines (scale) are formed on an outer peripheral surface of the filling tool 8 at pitches of 2 mm, for example, for measuring the amount of packing of the bone substitute, by a laser method or the like.

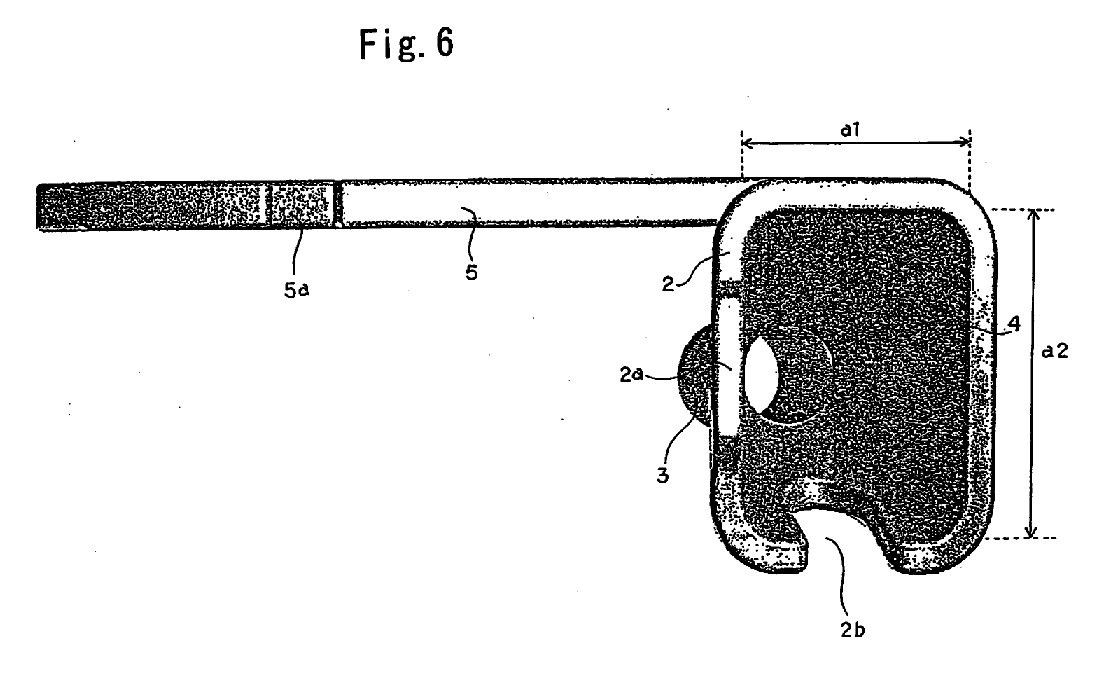

In the first embodiment, the large diameter opening portion 2 of the funnel 1 is formed into a substantially rectangular shape in plan view as shown in FIG. 2(a) and FIG. 6, and four corners of the substantially rectangular shape are rounded. The size of the large diameter opening portion 2 is determined so as to allow the insertion of the spoon 7 therein. In other words, the size of the large diameter opening portion 2 is determined for example such that the distances between sides opposed to each other of the substantially rectangular shape (see reference numerals a1 and a2 in FIG. 6) are larger than the distances between sides opposed to each other of the spoon 7 in the direction orthogonal to the longitudinal direction thereof (see reference sign b in FIG. 8).

In the first embodiment, the spoon 7 is formed to have a size which allows smooth insertion into a mouth cavity of a patient, for example, such that the size in the direction orthogonal to the longitudinal direction thereof (see reference sign b in FIG. 8) does not exceed approximately 15 mm, (more preferably, does not exceed approximately 10 mm). In the first embodiment, the size of the spoon 7 is determined so as to match the size of the large diameter opening portion 2 of the funnel 1, that is, so as to be received smoothly by the large diameter opening portion 2.

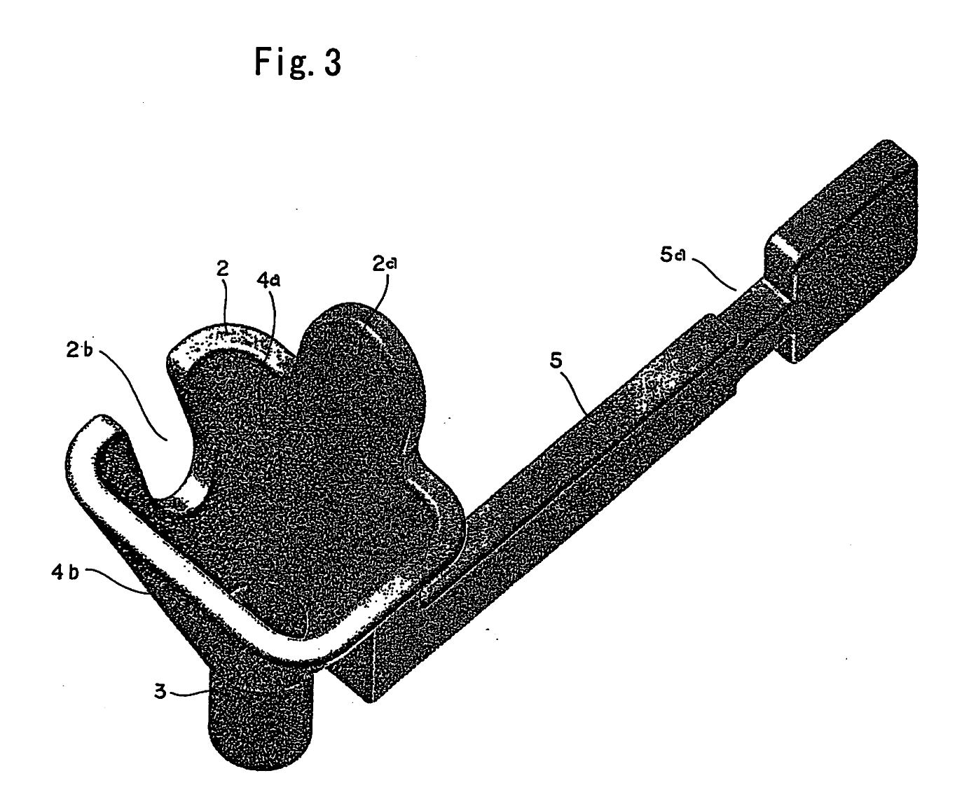

In the first embodiment, as shown in FIG. 3, one of four sides of the large diameter opening portion 2 is formed with a projection 2a projecting upward with respect to other portions (see also 2a in FIGS. 2(b), 2(d), and 2(e)). The shape of an upper end surface of the projection 2a is formed into a curved surface which allows a depressed surface 7a of the spoon 7 where the bone substitute is placed (see FIGS. 7 and 8) to be brought into abutment (contact) with the upper end surface of the projection 2a substantially entirely, that is, into a curved surface which matches a rounded shape of the depressed surface 7a of the spoon 7.

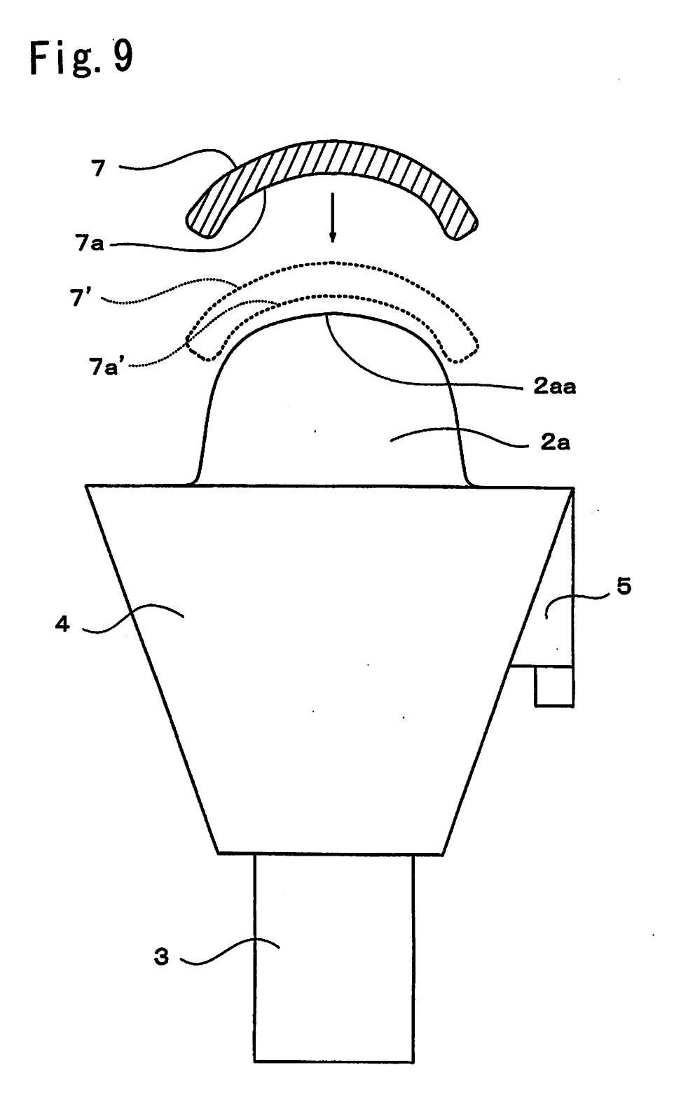

In other words, as shown in FIG. 9, the upper end surface 2aa of the projection 2a is formed into the curved surface substantially parallel to the curved surface of the depressed surface 7a of the spoon 7 (reference numeral 7 in FIG. 9 designates a center cross section of the spoon 7 imaginarily). Therefore, in the first embodiment, by rubbing the substantially entire part of the depressed surface 7a of the spoon 7 against the upper end surface 2aa of the projection 2a (see reference numerals 7′ and 7a′ indicated by a broken line in FIG. 9) by a user after having transferred the bone substitute from the spoon 7 into the large diameter opening portion 2 of the funnel 1, a remaining part of the bone substitute adhered to (remaining on) the depressed surface 7a of the spoon 7 can be dropped and transferred into the large diameter opening portion 2. In this configuration, a problem of waste such that the precious bone substitute is thrown away in a state of being adhered to (remaining on) the depressed surface 7a of the spoon 7 is avoided.

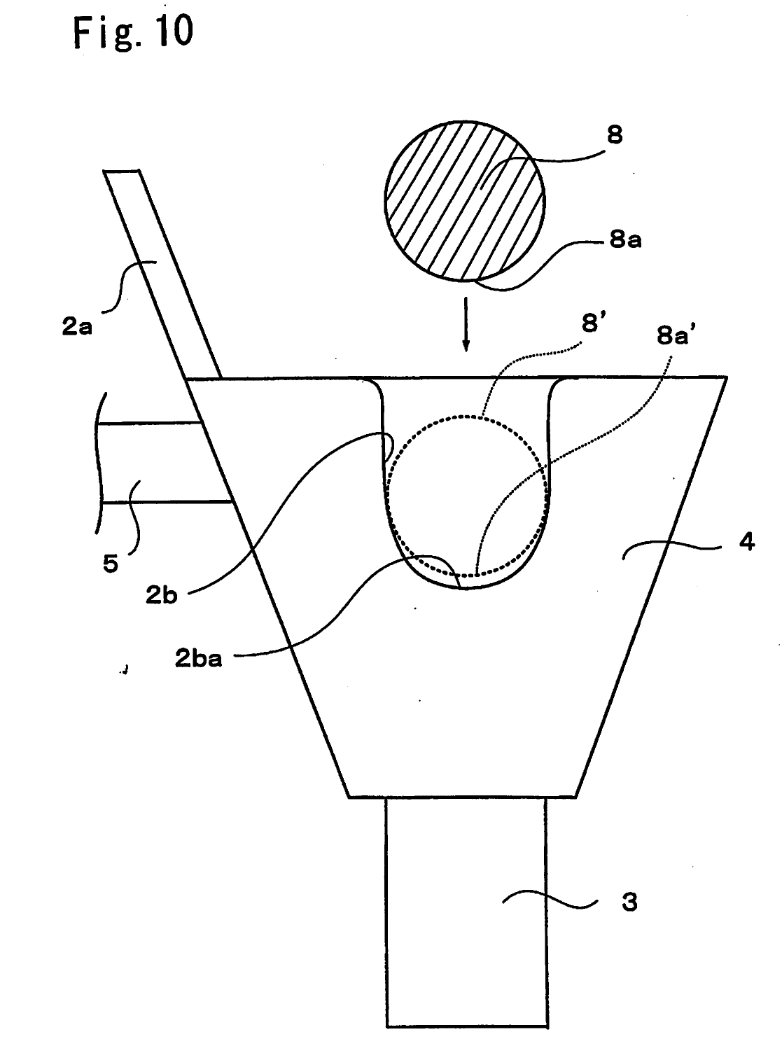

In the first embodiment, as shown in FIG. 3, one of the four sides of the large diameter opening portion 2 (a side different from the side where the projection 2a is formed) is formed with a depression 2b cut out downward in the drawing with respect to other portions (see also FIGS. 2(a), 2(b), and 2(c)). A lower end surface 2ba of the cut-out depression 2b (see FIG. 10) is formed to be an arcuate curved surface which allows substantially a uniform contact with a substantially half the outer peripheral surface of the filling tool 8 (see FIG. 7), that is, so as to be in an arc-shaped surface which substantially matches a rounded shape of the outer peripheral surface of the filling tool 8.

In other words, as shown in FIG. 10, the curved surface of the lower end surface 2ba of the depression 2b is formed in substantially parallel to the curved surface of an outer peripheral surface 8a of the filling tool 8 (in FIG. 10, the reference numeral 8 designates a cross section of the filling tool 8 imaginarily). Therefore, in the first embodiment, by rubbing a lower half of the outer peripheral surface 8a of the filling tool 8 shown in FIG. 10 against the lower end surface 2ba of the depression 2b (see reference numerals 8′ and 8a′ indicated by a broken line in FIG. 10) by the user after having pushed out the bone substitute in a hole toward maxillary sinus by using the filling tool 8, a remaining part of the bone substitute adhered to (remaining on) the lower half of the outer peripheral surface 8a of the filling tool 8 in the drawing can be dropped and transferred into the large diameter opening portion 2.

Then, the remaining part of the bone substitute adhered to (remaining on) an upper half of the outer peripheral surface 8a of the filling tool 8 in the drawing can be dropped and transferred to the large diameter opening portion 2 by the user by turning the upper half portion in the drawing of the outer peripheral surface 8a of the filling tool 8 shown in FIG. 10 by about 180° degrees so that the upper portion of the filling tool 8 in FIG. 10 comes on the lower side and rubbing the same in a state of being abutted against the lower end surface 2ba of the depression 2b in the same manner as described above. In this configuration, the problem of waste such that the precious bone substitute is thrown away in the state of being adhered to (remaining on) the outer peripheral surface 8a of the filling tool 8 is avoided.

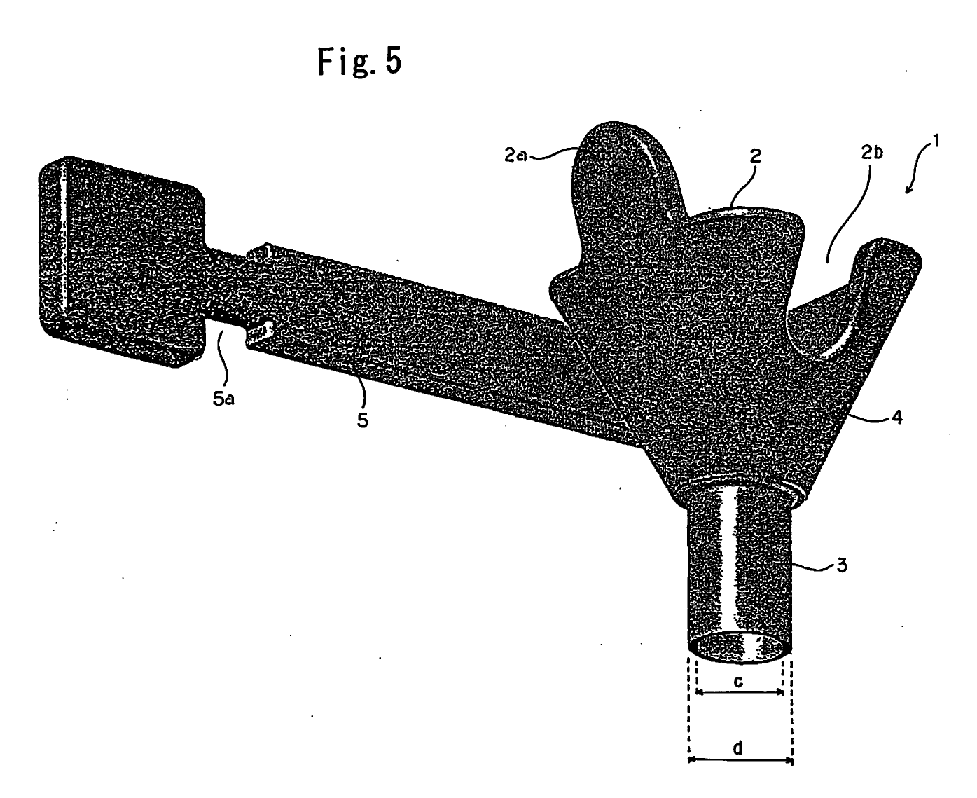

In the first embodiment, the small diameter opening portion 3 of the funnel 1 is formed into a substantially cylindrical shape as shown in FIG. 2C and FIG. 5. Also, an outer diameter of the small diameter opening portion 3 (see reference sign d in FIG. 2C and FIG. 5) is determined to have a size which allows easy insertion of the small diameter opening portion 3 into the hole on the maxilla of the patient from the side (or in a place) where the dental-implant is to be embedded. As things stand, the diameter of the hole from the side (or in the place) where the dental-implant is to be embedded is determined to be a size not exceeding approximately 6 mm so as to be the same or smaller than approximately 6 mm, which is the maximum outer diameter of a dental-implant in this field.

Therefore, the outer diameter of the small diameter opening portion 3 in the first embodiment is determined so as not to exceed approximately 6 mm, which is the same as, or smaller than the maximum diameter of the hole from the side (or in a place) where the dental-implant is to be embedded, that is, a size not exceeding approximately 6 mm, for example, 3 mm. A length of the small diameter opening portion 3 in the longitudinal direction (see reference sign f in FIG. 2(b)) is determined, for example, into approximately 2 to 10 mm.

In the first embodiment, an inner diameter of the small diameter opening portion 3 (see reference sign c in FIG. 2(c) and FIG. 5) is determined to the same size as or larger than the size of the diameter of a tube (or a cylinder) which allows smooth movement of the bone substitute without being clogged therein. In other words, the inner diameter of the small diameter opening portion 3 in the first embodiment is determined to the same size as or the larger size than approximately 2 mm, which is the minimum diameter which allows the smooth movement of the bone substitute in a cylinder, for example, to 2 mm (in a syringe in the related art, since the inner diameter of a distal end port thereof is smaller than 2 mm, there is a problem such that the bone substitute hardens and is clogged in the interior thereof, and hence cannot be discharged from the distal end port smoothly).

In the first embodiment, an outer diameter of the filling tool 8 in FIG. 7 is determined to be a size smaller than the inner diameter of the small diameter opening portion 3 so as to allow smooth passage and movement of the filling tool 8 in the small diameter opening portion 3.

In the first embodiment, as shown in FIG. 2(b), FIG. 3 and FIG. 5, the connecting portion 4 connects the large diameter opening portion 2 having the rectangular shape in plan view and the small diameter opening portion 3 having the substantially circular shape in plan view continuously. Also, an inner wall surface 4a and an outer wall surface 4b of the connecting portion 4 (see FIG. 3) are formed so as to be inclined at a predetermined angle with respect to a straight line (see reference sign e in FIG. 2(b)) which connects a center portion of the large diameter opening portion 2 and a center portion of the small diameter opening portion 3 (so as to form a tapered shape in which a surface area in the plan view is reduced gradually from the large diameter opening portion 2 to the small diameter opening portion 3).

In the first embodiment, the rod-shaped handle 5 is formed so as to extend from a part of the connecting portion 4 in the direction orthogonal to a line connecting the center portion of the small diameter opening portion 3 and the center portion of the large diameter opening portion 2 (see reference sign e in FIG. 2(b)) as shown in FIGS. 2(b), 2(c), and so on. As shown in FIG. 2(b), the handle 5 is formed with a narrowed portion 5a which is thinner than other portions at a midsection thereof. The narrowed portion 5a is formed for attaching a floss, a string, or a cord (not shown) to the handle 5 by winding or tying it therearound.

Subsequently, a method of using the funnel according to the first embodiment will be described. When a patient does not have a bone mass (thickness) required for embedding the dental-implant because the level of maxillary sinus floor of the patient is too low, it is required to increase the thickness of the bone on the side of maxillary sinus of the maxilla in the run-up to a process of embedding the dental-implant. The first embodiment is applied in the Socket Lift to be performed for increasing the thickness of the bone.

In the related art, in the Socket Lift, a hole (approximately 3 mm in diameter) is formed on a ridge (residual ridge) of the maxilla of the patient from the side (or in the place) where the dental-implant is to be embedded using a drill (for example, 2.8 mm in diameter), and an artificial bone substitute is stuffed therein.

In the novel method of Socket Lift invented by the present inventor, first of all, the small diameter opening portion 3 (3 mm or smaller in outer diameter) of the funnel 1 according to the first embodiment is inserted into the hole. Then, the double-head instrument 6 is taken out and the bone substitute is placed on the spoon 7 (see FIG. 7) provided at an end thereof, and the bone substitute is transferred from the spoon 7 onto the large diameter opening portion 2 of the funnel 1 (in this case, the bone substitute on the spoon 7 is prevented from flying in all directions of the hole by the large diameter opening portion 2). Then, immediately after that, the user moves the substantially entire part of the depressed surface 7a (see FIG. 7) of the spoon 7 while bringing the same into abutment with (rubbing the same against) the upper end surface 2aa (see FIG. 9) of the projection 2a of the large diameter opening portion 2 so as to prevent the bone substitute from remaining on the spoon 7. Accordingly, since the bone substitute adhered to the depressed surface 7a of the spoon 7 is dropped into the large diameter opening portion 2, the precious bone substitute is prevented from remaining on the spoon 7. The bone substitute transferred from the spoon 7 to the large diameter opening portion 2 moves smoothly downward on the inclined inner wall surface 4a of the connecting portion 4, moves to the small diameter opening portion 3, passes through the small diameter opening portion 3, and moves into the hole.

Then, the user inserts the filling tool 8 (see FIG. 7) provided at the other end of the double-head instrument 6 into the hole via the cylindrical small diameter opening portion 3. Then, the user pushes the bone substitute transferred into the hole toward the maxillary sinus floor little by little, thereby pushing maxillary sinus membrane upward by the bone substitute pushed into the maxillary sinus floor and stuffing the bone substitute between a bone surface of the maxillary sinus floor and the maxillary sinus membrane, by using the filling tool 8.

Accordingly, bone is proliferated on the maxillary sinus floor by an amount corresponding to the amount of the bone substitute stuffed between the bone surface of the maxillary sinus floor and the maxillary sinus membrane.

In order to proliferate the bone, a period for allowing the bone substitute to be cured sufficiently and integrated with the bone is necessary, and this period differs depending on the case. In this manner, when the bone is proliferated on the maxillary sinus floor and the thickness of the bone which enables embedding of the dental-implant is obtained, the embedding of the dental-implant can be performed. The method of embedding the dental-implant is publicly known in the related art and hence the description will be omitted.

As described above, in the first embodiment, when packing the bone substitute into the hole formed on the maxilla of the patient from the side (or in the place) where the dental-implant is to be embedded in the Socket Lift, the bone substitute placed on the spoon is transferred once from the spoon to the large diameter opening portion 2 of the funnel and then is transferred to the hole via the connecting portion 4 and the small diameter opening portion 3, so that the precious bone substitute is prevented from flying in all direction in the periphery of the hole and being wasted.

At this time, since the large diameter opening portion 2 formed into the substantially rectangular shape in plan view is formed in such a manner that the distance between the sides opposing to each other of the large diameter opening portion 2 is larger than the width of the spoon 7 (the dimension of the spoon 7 in the direction orthogonal to the longitudinal direction of the double-head instrument 6 in FIG. 7), transferring of the bone substitute from the spoon 7 to the large diameter opening portion 2 by inserting the spoon 7 into the large diameter opening portion 2 is achieved extremely easily.

In the first embodiment, as shown in FIG. 2(e) and so on, the large diameter opening portion 2 is formed partly with the projection 2a which matches the depressed surface 7a of the spoon 7 (see FIG. 7). Therefore, according to the first embodiment, by rubbing the depressed surface 7a of the spoon 7 against the upper end surface 2aa (see FIG. 9) of the projection 2a by the user after having transferred the bone substitute from the spoon 7 to the large diameter opening portion 2, the precious bone substitute (twenty to several tens of thousands yens per one gram) adhered to the depressed surface 7a of the spoon 7 can be transferred into the large diameter opening portion 2 completely.

In the first embodiment, as shown in FIG. 2(b) and so on, the large diameter opening portion 2 of the funnel 1 is formed with the depression 2b to which a substantially half of the outer peripheral surface of the distal end portion of the filling tool 8 (see FIG. 7) can abut.

Therefore, according to the first embodiment, by rubbing the outer peripheral surface of the filling tool 8 against the lower end surface 2ba (see FIG. 10) of the depression 2b by the user, after transferring the bone substitute in the hole onto the maxillary sinus floor of the patient, pushing the bone substitute to the maxillary sinus floor using the filling tool 8, and moving out the filling tool 8 from the interior of the hole, the precious bone substitute (twenty to several tens of thousands yens per one gram) adhered to the outer peripheral surface of the filling tool 8 can be transferred to the large diameter opening portion 2 completely.

In the first embodiment, the connecting portion 4 of the funnel 1 is provided with the substantially rod-shaped handle 5 for supporting the funnel 1 when inserting the small diameter opening portion 3 of the funnel 1 into the hole, or for supporting the funnel 1 when the small diameter opening portion 3 of the funnel 1 is inserted into the hole. Therefore, according to the first embodiment, in the Socket Lift, operation of the spoon 7 or the filling tool 8 with one hand while holding the funnel 1 with the other hand is enabled, so that the operation of the Socket Lift can be performed stably and smoothly.

In the first embodiment, the narrowed portion 5a is formed in the vicinity of an end portion of the handle 5 of the funnel 1 for attaching the string or the cord therearound. Therefore, according to the first embodiment, by winding or tying one end of the predetermined floss (string, not shown) around the narrowed portion 5a of the handle 5 and attaching the other end (free end) of the floss (string) around a finger of an operator or the like before packing the bone substitute using the funnel 1, erroneous swallowing the funnel during the operation of the Socket Lift is effectively prevented.

Although the embodiment has been described as far, the invention is not limited to those described as the embodiment above, and various modifications or changes may be made. For example, in the first embodiment, although the large diameter opening portion 2 is formed into the substantially rectangular shape in plan view, the invention is not limited thereto, and the shape of the large diameter opening portion in plan view may be a substantially polygonal shape, a substantially circular shape, or an substantially oval shape, for example, instead of the substantially rectangular shape. Although the horizontal cross-sectional shape of the connecting portion 4 is formed into a substantially rectangular shape in plan view (see FIG. 2(a)) according to the shape of the large diameter opening portion 2 which is formed into the substantially rectangular shape in plan view in the first embodiment, the present invention is not limited thereto, and the horizontal cross-sectional shape of the connecting portion in plan view may be formed into the substantially polygonal shape, the substantially circular shape, or the substantially oval shape instead of the substantially rectangular shape.

Although the handle 5 projects from the connecting portion 4 in the first embodiment, the invention is not limited thereto, and the handle 5 may be formed to project from the large diameter opening portion 2, for example. Although the large diameter opening portion 2, the connecting portion 4, the small diameter opening portion 3, and the handle 5 are formed integrally of the stainless material in the first embodiment, the invention is not limited thereto and, for example, a configuration in which the handle 5 is formed separately from the large diameter opening portion 2, the connecting portion 4, and the small diameter opening portion 3, and then the handle 5 is fixed to the large diameter opening portion 2 or the connecting portion 4 by welding or the like is also applicable.

Although the narrowed portion 5a for attaching the predetermined floss (string) is provided at the end portion of the handle 5 in the first embodiment, means for preventing the erroneous swallowing of the funnel in the invention is not limited thereto and, for example, a configuration in which a through-hole for inserting or fixing the floss (string) or the cord is formed in the handle 5, the large diameter opening portion, or the connecting portion is also applicable.

What is claimed is:

1. A bone substitute packing funnel used in Socket Lift for increasing a bone mass of maxilla of a patient to an amount which enables embedding of a dental-implant in the maxilla by proliferating bone of the maxilla on maxillary sinus floor of the patient by forming a hole on the maxilla of the patient from the side where the dental-implant is to be embedded and placing a bone substitute onto the maxillary sinus floor of the maxilla via the hole, when the bone mass of the maxilla of the patient is insufficient for embedding the dental-implant because the level of the maxillary sinus floor of the patient is too low, comprising:
a large diameter opening portion having a surface area in the plan view for allowing insertion of a spoon on which the bone substitute is placed and being configured to receive the bone substitute placed on the spoon from the spoon in a mouth cavity of the patient;
a small diameter opening portion formed into a cylindrical shape having an outer diameter not exceeding 6 mm, an inner diameter not smaller than 2 mm, and a length in the longitudinal direction from 2 to 10 mm, and being configured to be inserted into the hole formed on the maxilla of the patient from the side where the dental-implant is to be embedded, the small diameter opening portion allowing the bone substitute being transferred from the large diameter opening portion and the connecting portion to be transferred into the hole through the small diameter opening portion, allowing a substantially rod-shaped filling tool to be introduced into the hole through the small diameter opening portion, and allowing the bone substitute in the hole to move onto the maxillary sinus floor by the filling tool passed through the small diameter opening portion pushing out the bone substitute toward the maxillary sinus floor, when the small diameter opening portion is inserted into the hole in the mouth cavity of the patient; and
a connecting portion configured to connect a small diameter opening portion and the large diameter opening portion continuously and having an inner wall surface formed so as to incline with respect to a line connecting a center portion of the small diameter opening portion and a center portion of the large diameter opening portion, the connecting portion being configured to transfer the bone substitute received from the spoon into the large diameter opening portion of the funnel from the large diameter opening portion toward the small diameter opening portion smoothly in the mouth cavity of the patient.

2. The bone substitute packing funnel used in the Socket Lift according to claim 1, wherein the large diameter opening portion has a projection having a curved surface to which a substantially entire portion of a depressed surface of the spoon on which the bone substitute is placed can abut.

3. The bone substitute packing funnel used in the Socket Lift according to claim 1, wherein the large diameter opening portion has a depression having a curved surface to which an outer peripheral surface of a distal end portion of the filling tool can abut.

4. The bone substitute packing funnel used in the Socket Lift according to claim 1, further comprising a substantially rod-shaped handle extending from the large diameter opening portion or the connecting portion, the substantially rod-shaped handle being used by a user for supporting the funnel when inserting the small diameter opening portion of the funnel into the hole or for supporting the funnel when the small diameter opening portion of the funnel is inserted into the hole.

5. The bone substitute packing funnel used in the Socket Lift according to claim 1, wherein at least one of the large diameter opening portion, the connecting portion, and the handle has an attachment portion for attaching a string or a cord.
